(19) United States
(12) Patent Application Publication
(10) Pub. No.: US 2013/0191206 A1
(43) Pub. Date: Jul. 25, 2013

(54) SYSTEM AND METHOD FOR RATING THE VALUE OF ELECTRONIC OFFERS

(71) Applicants: Jerry Banks, Saratoga, CA (US); Shawn Rajabi, Danville, CA (US); Bobak Rajabi, Danville, CA (US)

(72) Inventors: Jerry Banks, Saratoga, CA (US); Shawn Rajabi, Danville, CA (US); Bobak Rajabi, Danville, CA (US)

(73) Assignee: Buy Local, Inc., San Ramon, CA (US)

(21) Appl. No.: 13/774,007

(22) Filed: Feb. 22, 2013

Related U.S. Application Data
(63) Continuation-in-part of application No. 13/354,492, filed on Jan. 20, 2012.

(51) Int. Cl. G06Q 30/02

(52) U.S. Cl. CPC G06Q 30/0239
USPC 705/14.39

(57) ABSTRACT

Methods and systems for providing a value rating for discount coupon offers.

### CROSS-REFERENCE

This application is a continuation-in-part of U.S. application Ser. No. 13/354,492 entitled System and Method for Creating, Identifying and Posting Content-Specific Electronic Offers, filed Jan. 20, 2012, and expressly incorporated herein by reference.

### BACKGROUND

The present disclosure relates to a network-based service that facilitates the display of discount coupon offers from business members or their agents to consumers and allows the coupon offers to be given a value rating by consumers, which can then also be displayed with the discount coupon offer. Business members consist of businesses that have been entered in the database of a network-based service provider. Dependent upon performance requirements and other factors the described invention can be implemented on a single server or across multiple servers.

Tools allowing for consumer feedback of various commercial endeavors exist, but are inadequate for providing meaningful measure of value for coupon offers. For example, Facebook social media includes a “Like” button, which is not quantifiable and does not allow for variable ratings of content. Another example is company/product star ratings offered by various web sites which allow consumers to express views on a company or a product. However, a product or company may have a “five star” rating but still offer coupons that rate low in terms of consumer value. Conversely, a “one star” rated company or product may offer a discount coupon that has a very high rating because the rating is for the discount offer and not for the product or the company offering the product.

In today's world, a common marketing tool for businesses is to send emails to potential customers. This method requires companies to acquire electronic addresses of potential customers and then send electronic mailings to those potential customers via email. These electronic mailings (emails) must include a recipient's electronic address. They are received by any recipient for whom the sending company has a valid email address and may be sent by any business, of any size, anywhere on earth regardless of whether or not the business has a local physical address from which to pick up the purchased merchandise or if they are a one person electronic mail order web site. Often times the emails are unsolicited and contain information not wanted, needed, or requested by the recipient. Such unsolicited emails are commonly referred to as SPAM. Sometimes the emails are welcomed but more often than not they contain information that is not useful to the recipient. The recipient has no say in having these emails sent to them as it only requires someone providing the sending company with the recipients email address and the sending company then taking the step of sending out unsolicited email. These email advertisements may or may not contain a discount coupon, and there may be no independent means for the consumer viewing a potential coupon to assess the true value of the discount being offered

Another means to reach potential customers electronically is to post advertisements on various web sites and hope that a potential customer sees the ad and acts on it. This does not require knowing a specific email address but does require that the target customers visit the web page on which the advertisement is placed, and also requires that they notice the ad and act on it. Acting on this type of advertisement also allows the search engine to capture information about the site visitor which they may use for other purposes. There is no guarantee that the advertisement involves a discount offer to the consumer nor is there an independent means to assess the value of any discount offer.

Another means for a consumer to find content specific data is through Internet search and social media engines. Internet search engines such as Google.com, Bing.com, Yahoo.com, and others allow site visitors to enter information into a search box and then display links to various pages on the Internet that are intended to relate to the data keyed into the search box. Web search companies can also display advertising based upon the same data that was keyed into the search box to provide advertising that may be deemed more relevant to the person doing the searching.

These search results and the advertisements presented are content specific as they are based upon what a site visitor entered into a search box before initiating a search. From the search results page, the visitor views and selects from a number of possible search results containing links on a number of possible pages that will take the visitor to a pre-existing web page describing some facet of the information being searched for. Similarly, if the visitor views and clicks on one of the advertisements presented on the search results page, he/she is then similarly taken to a pre-existing web page related to the information that was keyed into the search box. Alternatively, site visitors to a search engine web site can set up search parameters that will automatically scan the Internet for newly published web pages (those pages published since the last automated search) and then email those web page links to the site visitors email address. None of these options offer an independent rating of the discount coupon offer to help the consumer assess the value of the offer.

Social media site Twitter.com allows searches of “Tweets” and these can be topic specific if the recipient is signed in and performs a real time search for specific words. Twitter also offers “Promoted” Tweets/Trends that are sent to a senders existing “followers” with the difference from a non-“Promoted” Tweet being that these Promoted Tweets do not show up on the “followers” “timeline” until the “follower” signs in and views his/her timeline. After that point the promoted tweets scroll down like all the other tweets. Additionally tweets can be sent by anyone in the world who registers with Twitter and received by any Twitter member with access to Twitter.com.

### BRIEF DESCRIPTION OF THE DRAWINGS

FIG. 1 is a block diagram that depicts a conventional flow for sending a standard email solicitation from a sender to a recipient.

FIG. 2 is a block diagram that depicts an improved flow in which a discount coupon offer is created and placed in an input port to be made available for a potential recipient to review and possibly use.

FIG. 3 is a block diagram depicting an external message delivery via email.

FIG. 4 is a block diagram depicting an internal message delivery system.

FIG. 5 is a block diagram depicting multiple systems connected together using the standard Internet Protocol.

FIG. 6 depicts Consumer Members spaced in set geographical locations and identifying those Consumer Members that are within the Business Radius of a specific Business Member.

FIG. 7 depicts Business Members spaced in set geographical locations in relation to a Consumer Member's set geographical location and identifying those Business Members from whom the Consumer Member could choose to view discount coupon offers created by Business Members within that radius.

FIG. 8 depicts how the radius for Business Members can vary dependent upon different parameters set by a Consumer Member.

FIG. 9 depicts how a business may choose to direct specific discount coupon offers to a specific geographical location.

FIG. 10 is a block diagram showing a system embodiment as implemented on the World Wide Web.

FIG. 11 depicts how key terms from Consumer Members are compiled and provided to Business Members.

FIG. 12 is a block diagram of an alternative system embodiment in which value ratings of discount coupon offers are made and stored on a coupon server and displayed via a web server.

FIG. 13 illustrates value ratings being displayed in conjunction with corresponding discount coupon offers using letters for the value rating

FIG. 14 illustrates value ratings being displayed in conjunction with corresponding discount coupon offers using numbers for the value rating

### DETAILED DESCRIPTION

This disclosure is directed to a method of providing a network-based service that matches consumers with discount offers of local merchants. The network-based service allows businesses to create discount offers, which are then posted on the network-based service, or provided for display, or otherwise made available by the service to consumers. In one embodiment, such offers are only made available to consumers who are within some limited distance or geographical area from store locations of the businesses. The consumers may also have expressed interest in particular content offered by one or more of the businesses, and these coupons can be shown or provided to the consumers while maintaining the consumers' anonymity from the business member. Further, these discount coupon offers can have a value rating, which gives an indication of the overall value of the particular offer as determined by other consumers, for example, who have provided input indicative of their perceived value of the discount coupon offer.

Alternatively, the initial value rating of a discount offer may be created by business members/agents or the service provider, with the rating later modified or replaced by value ratings input by consumers. Consumers may thus place quantifiable value ratings on specific discount coupon offers, such that the assigned value of a particular discount coupon offer is independent of the company offering the product or the product itself.

This disclosure describes an alternative to the current email delivery system and traditional web advertising. In contrast to conventional email delivery, a method is described for creating, delivering, and receiving discount coupon offers that is independent of a recipient's email address and does not specifically require the use of an email delivery system. These discount coupon offers are made available to recipients from a network-based service based upon the content of the discount coupon offers, and/or the business offering the discount coupon offer and/or the most recent discount coupon offers offered via a network service provider, and typically include a limit on the distance from the recipient of the business offering the discounted product or service. In addition, discount coupon offers may include a consumer created value rating in the post of the offer to give other consumers an idea of how valuable this coupon offer may be to them. Discount coupon offers displayed as disclosed herein can target an audience that has specifically chosen to receive discount coupon offers with specific content without the sender needing to know a recipient's name, electronic address, or any other personal information about the recipient.

Thus, the target consumer need not explore the Internet and happen upon a Web advertisement that may contain information of interest and may or may not contain a discount offer on a product or service. Discount coupon offers that contain the information and value rating that a consumer is requesting can be captured automatically based upon settings made by the consumer, and qualifying discount coupon offers can be made available to consumers via a personal inbox provided by the service provider, or may be sent by other means as configured by the requesting consumer. For example, email notifications or other electronic means may be used to notify the consumer member of the discount coupon offers.

There is also no search of pre-existing web pages. Instead, the Consumer Member has the option to enter information into a programmable “Data Receptor” and enter or select a minimum Value Rating which is then used to scan live discount coupon offers as they are created by Business Members and entered into the system. The data in the programmable Data Receptor is not being used to look for pre-existing web pages. Whereas a web page search engine may or may not turn up results that include coupon discounts, the method of the present disclosure only turns up discount coupon offers.

In one preferred embodiment, Company A is a provider of Network-based services, and in the course of doing so, maintains a database of registered businesses (Business Members) and a database of registered consumers (Consumer Members) who may be interested in buying goods or services from one or more of the Business Members. The Consumer Members have the ability to enter specific topics of interest into programmable “Data Receptors”, including selecting or entering a minimum discount value coupon rating, and the data receptors are coupled to a database of the network-based service.

Business Members are able to create special message offers, such as discount coupons and/or special value deals on goods/services, by accessing the network-based service through a Business Member specific input port. The contents of these offers are placed on a Message Transmission Medium to which the Data Receptors are connected. This Message Transmission Medium may be the same or another database(s) set up specifically for the analysis and transmission of such messages. The network-based service matches data placed in the Data Receptors and the minimum discount coupon offer value rating chosen by the consumer with one or more discount coupon offers created by a Business, then places the discount coupon offer(s) in the accounts of any of the Consumer Members having a match and who are within a set radius of the business location of the Business Member.

For example, if a registered consumer enters certain key words or phrases into their Data Receptor, such as “Flat Screen LED Television” or “Pedicure” with a minimum value rating of at least 7 out of 10, then any discount coupon offers created by a Business Member that contains those key words or phrases and that minimum value rating will automatically be made available to the data receptors of the Consumer Member who is within the set radius and meets any other established parameters of the service and the offer. The receiving Consumer Member could then choose to act on the information provided in the discount coupon offer or not. The Business Member would only find out the Consumer Member has received the discount coupon offer if and when the Consumer Member contacts the Business Member regarding the discount coupon offer. The Consumer Member could be provided with a number of different ways to act on this discount coupon offer, for example, by downloading the coupon, printing it and taking it to the physical business location of the sending Business Member for redemption, or by downloading the coupon into a portable device and displaying it in electronic fashion at the physical business location of the sending Business Member for redemption. Alternatively, the recipient Consumer Member may select a link within the electronic version of the discount coupon offer to complete the financial portion of the transaction electronically directly with the Business Member, and then proceed to the physical location of the Business Member to finalize the terms of the offer, which may simply involve picking up a product that was paid for online. This allows Consumer Members to put up requests to receive discount coupon offers on products and services without giving up their anonymity.

The service has access to all the key terms which Consumer Members have entered into the programmable Data Receptors, and could compile an anonymous listing of that information and provide it to the Business Members. Business Members would then have the option of creating discount coupon offers which match exactly with what at least some Consumer Members are looking for. This should greatly increase the likelihood that a Consumer Member will act on a specific discount offer and that a Business Member will make a sale. Additionally, the service has access to all the discount coupon offers being created and sent by the Business Members or their agents. This allows the service to provide an overall listing of these discount coupon offers and their value ratings for Consumer Members to review without necessarily requiring Consumer Members to set up a programmable Data Receptor.

In one embodiment, a multi-tiered coupon system could be implemented. For example, discount coupon offers with lower value ratings, will be available for display and use by any consumer without becoming a registered user of the service provider as part of a standard search results page. Higher value rated discount coupon offers will only be available for use by registered Consumer Members of a network-based service provided by Company A. There could be several tiers of higher value discounts based upon various factors. One such example would be how often a Consumer Member uses the services of network-based service provider Company A. Based on whatever criteria that is set by network-based service provider Company A, only Consumer Members who meet that criteria would be able to use the higher level discounts offered by the Business Members of network-based service provider Company A. Company A would not need to provide Consumer Member information to the offering Business Member to provide such higher valued discount coupon offers.

A particular discount coupon offer may not yet be rated. This value rating of “unrated” or some other indication that a particular discount coupon offer was yet to be rated, including a blank field, could be displayed with the discount coupon offer and/or on a search results page for the business making the discount coupon offer until a consumer generated discount value rating was available. The value rating indicates the level of the discount coupon offer being offered by the Business Member. For example, if letter grades were chosen as the unit of measure, an “A” value rating would typically indicate that the discount offer was of a greater value than a “B” value rating (similar to a school's grading system where an “A” grade is of higher value than a “B” grade).

There could also be a numeric or other quantifiable grading system, such as a scale of 1 to 10, or some other scale that could be used to identify the value of the discount coupon offer. In either case, once the discount coupon offer is available for viewing by consumers, consumers may input their own value rating of the discount coupon offer. This consumer created value rating may be displayed separately and/or averaged with other consumer created values for that particular offer. This value rating would be an ongoing process and the value rating could change as more and more consumers provide their own value rating of a particular discount coupon offer.

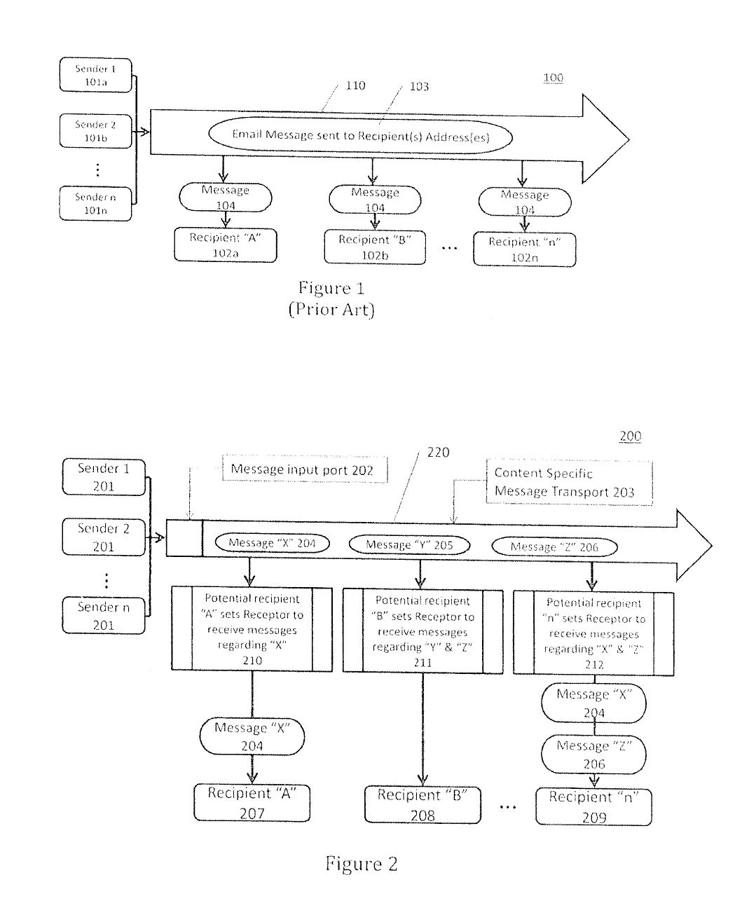

As illustrated in the schematic flow diagram of FIG. 1, a conventional email distribution system 100 for commercial marketing offers includes a group of senders 101a, 101b . . . 101n and a group of generic recipients 102a, 102b . . . 102n connected through one or more network-based messaging services 110. The senders 101 who desire to send an email solicitation to any such group of recipients 102 must first obtain the electronic addresses for those specific recipients, for example, by developing or acquiring a list of such addresses and/or other known means. The recipients 102 are deemed generic in that they have not sought out the email offers of senders 101. Senders 101 then craft an email message 103 and send it through network service 110 to the inboxes 104 of recipients 102 for whom they have acquired email addresses. The recipients 102 who receive these emails 103 are likely not expecting to receive the emails, and therefore they may automatically be sent to a Spam folder or simply ignored by the recipient, thus defeating the commercial efforts of the sender.

As illustrated in the schematic flow diagram of FIG. 2, an improved distribution system 200 for commercial marketing offers includes a group of senders 201a, 201b . . . 201n and a group of recipients 102a, 102b . . . 102n connected through a network-based service 220. In this embodiment, the network-based service 220 includes an input port 202 for Business Members or their agents, namely a connection or interface through which senders 201 may access an Offer Transport service 203 to create discount coupon offers for consumer/recipients. The discount coupon offers are then sent by the Offer Transport service 203 to outport ports 210 assigned to consumer/recipients based on settings programmed into these “data receptors” for and by each consumer/recipient, including the content searched for by the consumer/recipient. For example, data receptor 210 is coupled to network-based service 220 and is programmed to receive offers by recipient 207 (“person A”), for example, regarding content “X;” data receptor 211 is coupled to network-based service 220 and is programmed to receive offers regarding content “Y” and content “Z” by recipient 208 (“person B”); and data receptor 212 is coupled to network-based service 220 and is programmed to receive offers regarding content “X” and content “Z” by recipient 209 (“person n”). The senders and recipients preferably subscribe as members to the network-based service and are therefore sometimes referred to as Business Members and Consumer Members respectively. As part of their subscription, Consumer Members may provide an address or location, and may also provide a limit for the distance they are willing to travel to redeem discount coupon offers at the physical store locations of participating Business Members.

In accord with one preferred embodiment, a Consumer Member who uses the network-based service to search for specified content, such as X, Y, or Z (including coupon value ratings) in the example above, will receive discount coupon offers regarding the specified content from Business Members having a store located with the preset distance to travel set of the Consumer Member. The Business Members do not obtain or have access to the email addresses of the Consumer Members to whom the service sends discount coupon offers, unless the Consumer Member consents to such use. Thus, in FIG. 2, some or all of the listed Business Members 201 have created discount coupon offers with network-based service 220, and the service sends those discount coupon offers to the appropriate Consumer Members. For example, a Business Member created discount coupon offer 204 relating to content “X”, a Business Member (it may be the same or a different Business Member) created discount coupon offer 205 relating to content “Y”, and a Business Member (same or different) created discount coupon offer 206 relating to content “Z”. These offers are collected and distributed by the network-based service 220 to data receptors of Consumer Members based on settings of the Consumer Members.

On the receiving end, recipient A 207 received the discount coupon offers relating to “X” as that was set in the associated Data Receptor 210 and recipient A is within the established distance range of the particular Business Member that created the offer. Recipient B 208 requested discount coupon offers relating to “Y” and “Z”, and therefore offers 205 and 206 are relevant, but recipient B did not receive these offers because Recipient B is not within the established radius of any of the sending Business Members that created these offers related to “Y” or “Z”. Recipient “n” 209 received discount coupon offers 204 and 206 relating to “X” and “Z” as it is within the established radius of the sending Business Members. One feature of the service is that Business Members do not know or have access to the electronic addresses of the recipients who have received their discount coupon offers. Any Consumer Member may set up multiple Data Receptors and any Business Member may send out multiple content specific discount coupon offers on the message network.

The “Content Specific Message Transport” 203 could be in the form of a dedicated database which receives data from a Business Member through a specific input port, then searches the various programmable data receptors and places the matching discount coupon offers into the data receptors of the appropriate Consumer Member.

According to methods disclosed herein, only those potential recipient Consumer Members who sign up to receive topic specific discount coupon offers and are within a specific radius of the sending Business Members will receive them. In fact, it is possible that sending members can generate and send discount coupon offers to the service that will not be received by any potential recipient, as represented by Message “Y” 205 in FIG. 2.

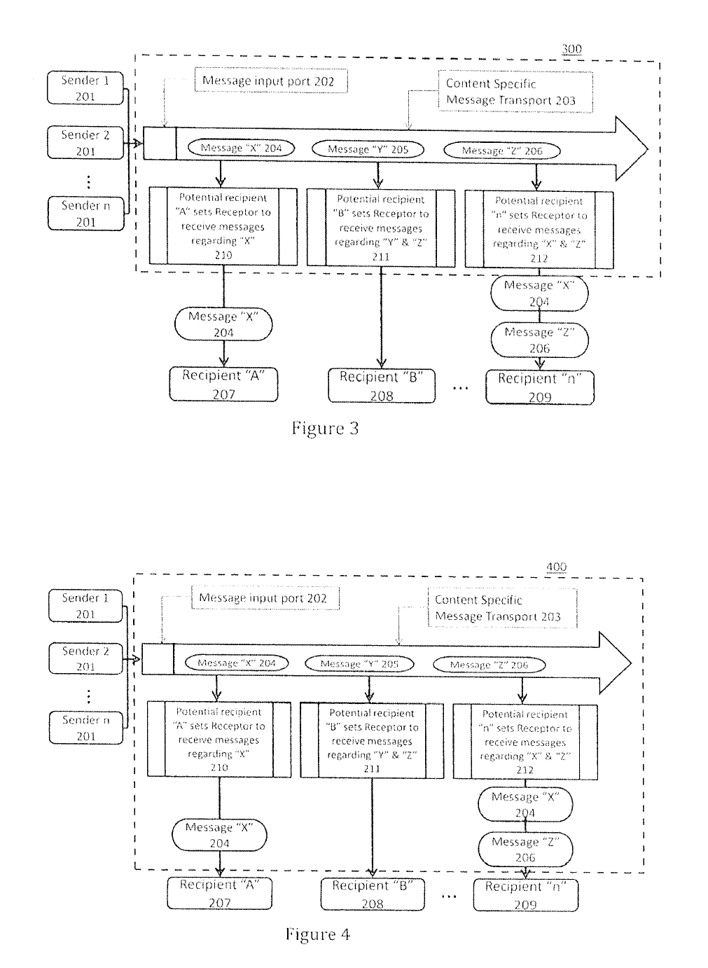

As shown in FIG. 3, discount coupon offers acquired by the programmable Data Receptors can be sent to the recipient's email inbox external to the system of the network-based service. This would require the system to be aware of and keep track of the recipient member's email address, but the address would still be kept anonymous to the message sender. As shown in FIG. 4, these messages could also remain resident within the system of the network-based service for access by the recipient when they return and sign in to their account on which the content specific message delivery system resides.

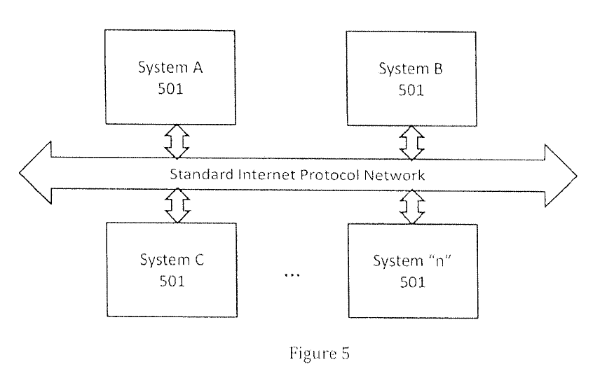

In some cases, it may not be practical to scale a single content specific delivery message system as described beyond a certain number of members or transactions. However, as shown in FIG. 5, it is possible to connect several systems 501, such as systems A, B, C n, where each system is connected, for example, through a network such as the existing Internet using the Standard Internet Protocol. Each system 501 is similar to the system 200 described in FIG. 2. In this way, scaling could be performed on a global basis without building a dedicated communications medium in parallel with the existing Internet. Different web sites or data centers that were optimized to take advantage of the content specific message delivery system could send content specific electronic messages across a broader network by transmitting these messages in a structured format across the existing Internet and then re-constructing the information in a format to be used for the methods described herein.

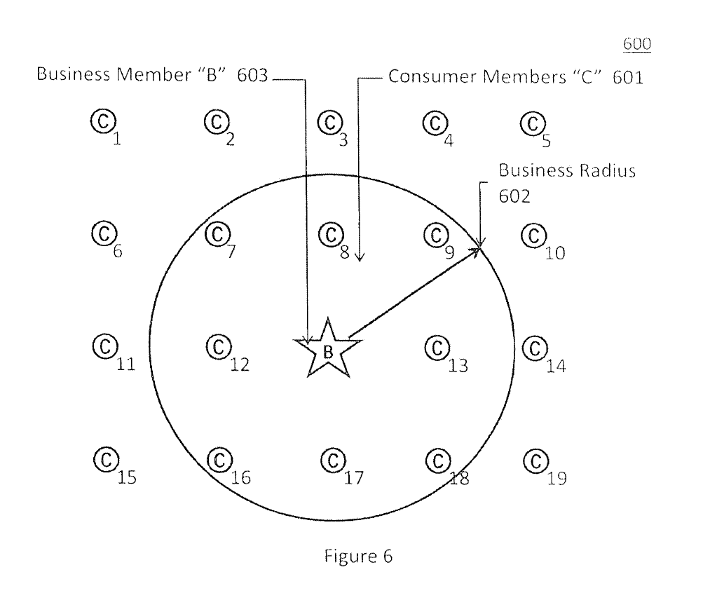

FIG. 6 illustrates one scenario for determining which Consumer Members C1, C2 . . . C19 are eligible to receive discount coupon offers from Business Member B 603 based upon the distance of the Consumer Member from the physical address (Business Radius) of the Business Member. Whether or not these potentially eligible Consumer Members receive a discount coupon offer sent by Business Member B is dependent upon content settings these Consumer Members make in their programmable Data Receptors matching the topic of the discount coupon offer sent by Business Member B (including a discount coupon value rating). Determining whether the location of a Consumer Member set location falls within the fixed Business Radius of a sending Business Member is performed by computer algorithms calculating the distances between the physical address of the Business Member and the address set by the Consumer Members (which may be independent of the Consumer Member's current location). In FIG. 6, it is apparent that only Consumer Members C7, C8, C9, C12, C13, C16, C17 and C18 are within the fixed Business Radius 602 of Business Member B, and therefore, in this fixed radius example, only Consumer Members C7, C8, C9, C12, C13, C16, C17 and C18 are eligible to receive offers from Business Member B.

Although FIG. 6 indicates a fixed Business Radius 602, this Business Radius can be set independently by the Consumer Member (for example, as a preference: maximum distance to travel), the Business Member (different messages could have different distribution radii), and/or the company providing the Internet based services (as a default setting, or several limited choices). A priority based algorithm can be used to determine which Business Radius overrides other settings. For example, a Business Radius set by the Consumer can override the Business Radius 602 set by the Business, or the company providing the Network based service can establish a default “Business Radius” if neither the business nor the consumer has set one. Conditions for reception of a discount coupon offer that extend beyond the Business Radius are established by the Consumer Member.

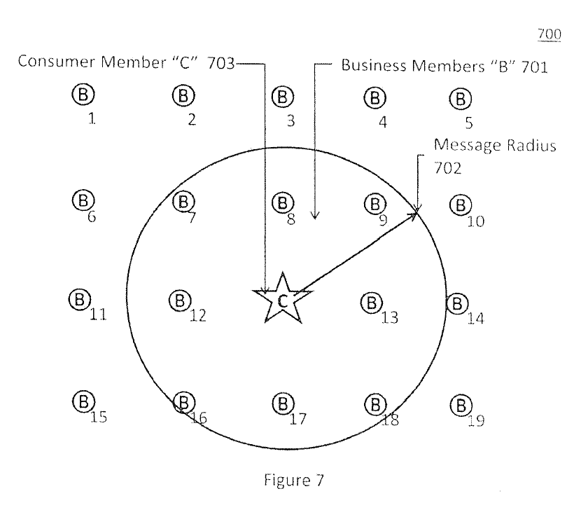

FIG. 7 illustrates an alternative scenario whereby Consumer Member C 703 has set a fixed Message Radius 702 representing the maximum distance this member will travel to redeem an offer. Various Business Members 701, including members B7, B8, B9, B12, B13, B16, B17 and B18, are shown within the set “Message Radius” 702 of the set location of Consumer Member C 703. These Business Members may be sending out discount coupon offers at any time on the “Content Specific Message Transport” 203 that do not match any criteria set by the Consumer Member in his/her Data Receptors and consequently may not have been automatically captured in the Consumer Member's inbox.

A Consumer Member may choose to view these messages on line by signing in to the Network service company's Network service and selecting a “show discount coupons” option for a Business Member or for Business Members within a certain Message Radius 702 of the fixed location of Consumer Member 703 (independent of the current location of the Consumer Member). The Consumer Member could have the option to show all discount coupon offers within a radius or those from a specific Business Member or those that match some search criteria. Messages viewed in this fashion may extend beyond the scope of any specific topics they have set up their Data Receptors to receive. These discount coupon offers may not have otherwise appeared in the Consumer Members inbox.

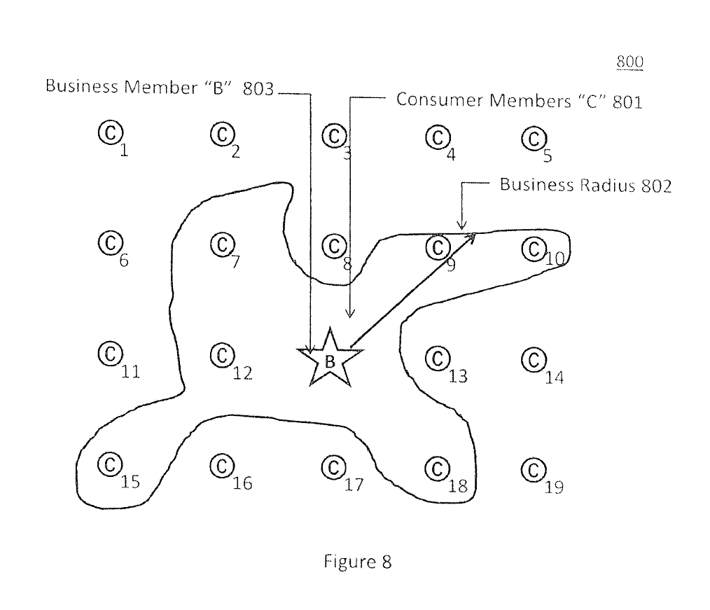

FIG. 8 illustrates how the Business Radius 802 may change dependent upon parameters set by a consumer. These parameters may include the distance a Consumer Member has set to travel for that particular business or for the discount coupon offer type that any Business Member might create and send. A Consumer Member may be willing to travel any distance to receive a message from a specific Business Member or a Consumer Member may want to limit the distance of the Business Radius based upon the type of product/service discount being sought. In this example, based on settings of the Consumer Members, the effective business radius 802 is not a radius at all, but a ragged line that encircles and includes only Consumer Members C7, C9, C10, C12, C15 and C18 within defined area 802 for Business Member B 803.

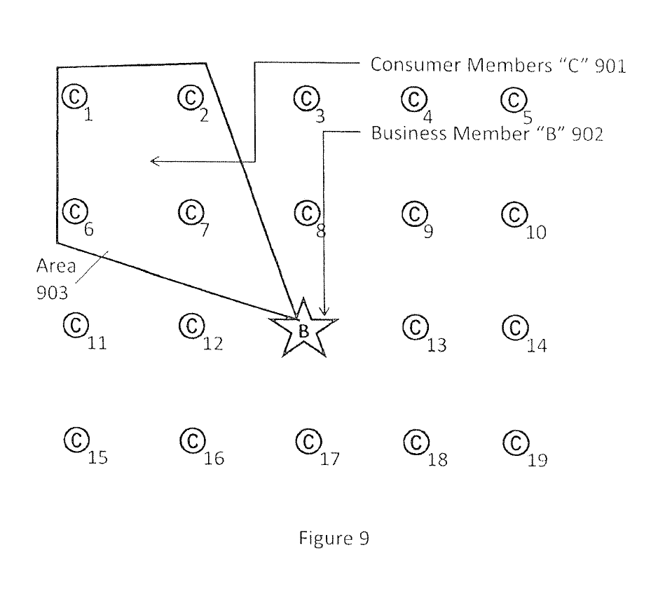

FIG. 9 illustrates how a Business Member B 902 chooses to provide discount coupon offers to only a certain limited geographical area/region 901 containing only Consumer Members C1, C2, C6 and C7. The Business Member does not know the identification or addresses of any the Consumer Members who may be in the targeted geographical area/region 901 (if any), but the Business Member may nevertheless choose to provide their discount coupon offer(s) only to potential Consumer Members who are in a particular geographical region, such as region 901. In this case the Network based service company will only allow Consumer Members within that geographical region 901 to have the ability to view any such discount coupon offers. This can be done anonymously to the Business Member as the registration information of the Consumer Member is only known by the Network service based company. Further, this may be a fee based service offered to Business Members.

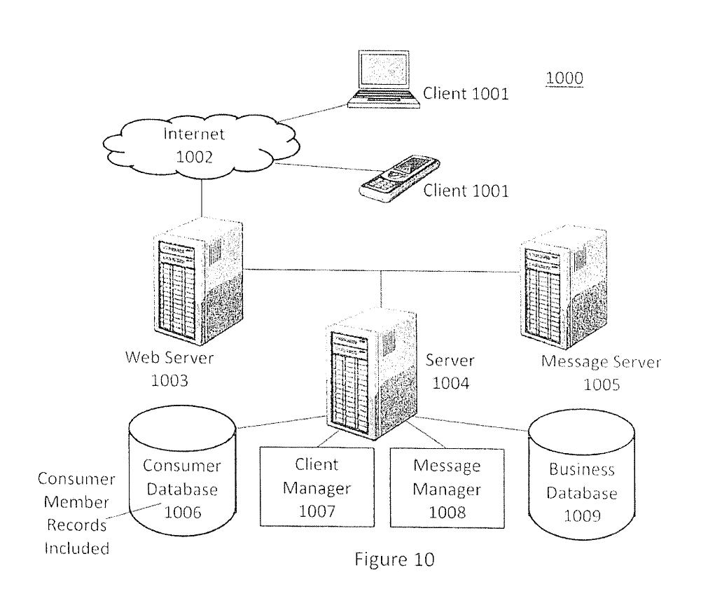

Referring now to FIG. 10, a communication and computer network system 1000 is illustrated that implements one or more of the described embodiments. In system 1000, one or more client devices 1001 interact with a web server 1003 and a message server 1005 through a network 1002, such as the Internet. The web server 1003 may provide hosted services, for example, with a server computer 1004 which runs various software modules including a Client Manager 1007 and a Discount Coupon Offer Manager 1008. The server computer 1004 is also coupled to a Consumer Database 1006 and a Business Database 1009, which contain specific information about Consumer Members and Business Members, including address information that is used to calculate the distance component of message delivery to the Consumer Member. Consumer Database 1006 also contains the programmable Data Receptor information set by each Consumer Member, for example, through client device 1001.

Client Manager 1007 manages information about the Client 1001. Such information includes whether the client is signed in to the service or if the client is a Consumer Member or a Business Member. Each type of client would be permitted to see different levels of web pages and perform certain functions only available to specific clients. Consumer Database 1006 also contains the message inbox for each Consumer Member which is accessible to the Consumer Member only when signed in. Discount Coupon Offer Manager 1008 would determine how discount coupon offers are sent from Business Members and which Consumer Members would be able to see these discount coupon offers based upon distance, topic, and other parameters. The distance calculation between a street address of a Business Member and a location of a Consumer Member is independent of the current position of the Consumer Member. The location of the Consumer Member is pre-set and entered in the Consumer Database 1006. It does not change as the Consumer Member travels unless the Consumer Member specifically enters in a new location. Discount Coupon Offer Server 1005 contains the Discount Coupon Offers created and sent by the Business Members.

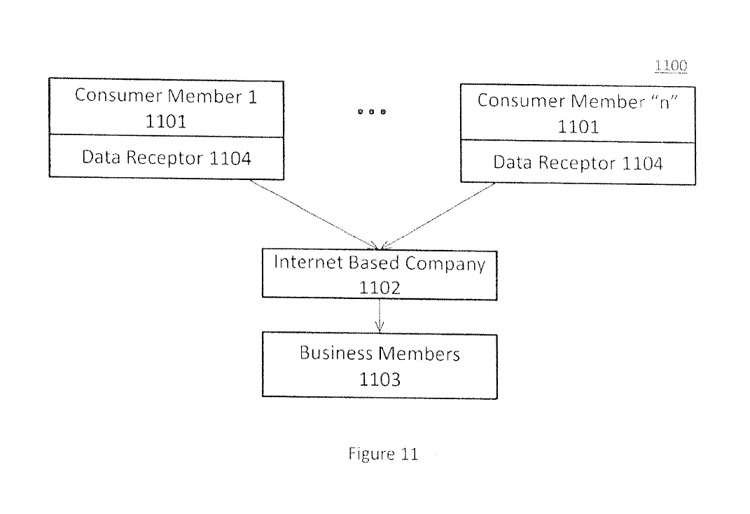

FIG. 11 illustrates schematically how the Network based service company 1102 has access to the key terms that Consumer Members 1101 have set in their programmable Data Receptors 1104. This data is aggregated by the service company 1102 and provided to the Business Members 1103 in summary, anonymous manner to allow the Business Members to create focused and optimized discount coupon offers which match with what Consumer Members 1101 are requesting.

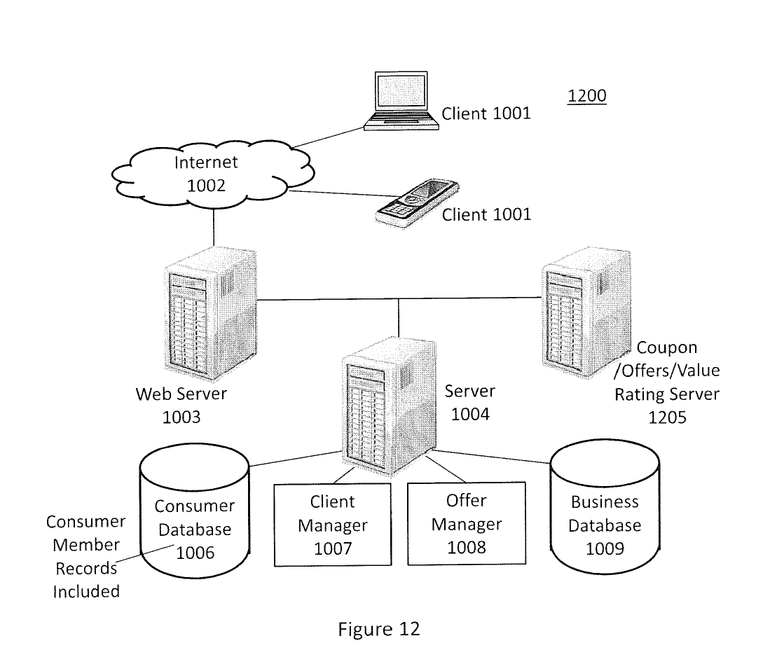

FIG. 12 illustrates a system 1200 that includes a coupon/offers/value rating server 1205 that hosts discount coupon descriptions that are served on a web site through Web Server 1003 and their associated value ratings. Each coupon description can have at least one value rating associated with each coupon description, including the possibility of a “Not Rated” rating. Alternatively, the value rating can be set by any of the source entities involved: the Business Member or its agent offering the discount coupon on server 1205; the Network service provider displaying the discount coupon offer; or a consumer, through Client 1001, can provide input in the form of a value rating on a particular discount coupon offer.

The value ratings from the consumer can be displayed individually or averaged with other consumer value ratings to create a new value rating for a discount coupon offer. This consumer created value rating can be displayed in a variety of ways. For example, the value rating can be displayed next to a description of the discount coupon offer being made by the Business Member/agent, or next to a value rating created by a consumer. The consumer created value rating can also be averaged with a value rating provided by the Business Member/agent and/or the network-based service provider to create a new value rating. The value rating should be based on perceived overall value and may or may not be directly tied to a specific percentage discount.

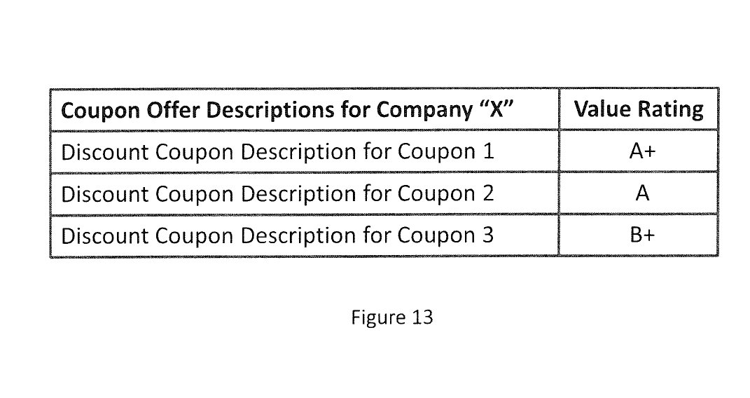

FIG. 13 is an example illustrating discount coupon offers from Company “X” being displayed with their corresponding value ratings. Discount Coupon Offer Description 1 is associated with an “A+” value rating. Discount Coupon Offer Description 2 is associated with an “A” value rating. Discount Coupon Offer Description 3 is associated with a “B+” value rating. For the purposes of this illustration, the “A+” value rated coupon offer is perceived to be of a higher value than the “A” value rated coupon offer, which in turn is perceived to be of a higher value than the “B+” value rated coupon offer.

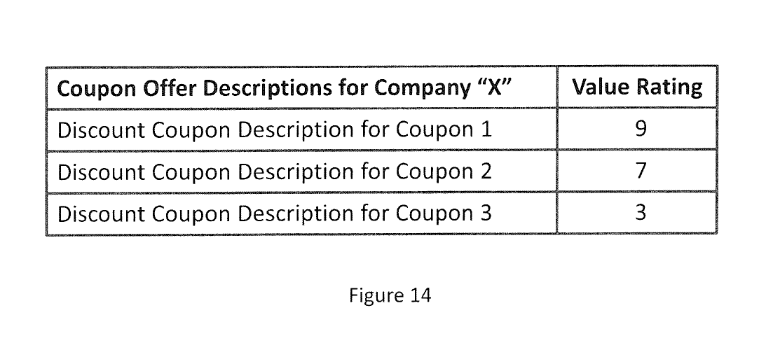

FIG. 14 is an example illustrating discount coupon offers similar to FIG. 13 but using a numeric value rating. The rating system could also be any other quantifiable system for providing ratings. It could even be a combination of different valuation systems that would then be correlated to provide a final value rating. One such example would be to initially post a letter grade rating, but have consumers enter a value based on a numeric rating that would then be converted to a letter grade.

While one or more implementations have been described by way of example and in terms of specific embodiments, it should be understood such descriptions are not intended to be limiting. To the contrary, this description is intended to cover various modifications and similar arrangements as would be apparent to those skilled in the art. Therefore, the scope of the claims that follow should be accorded the broadest reasonable interpretation that encompasses all such modifications and similar arrangements.

1. A method for providing discount coupon offers to consumers, comprising:
receiving at a server at least one discount coupon offer from at least one business member; and
receiving at the server at least one value rating for the discount coupon offer; and
posting at the server the discount coupon offer together with its value rating; and
providing access to the posting at the server to a plurality of consumer members.

2. The method of claim 1, further comprising transmitting the discount coupon offer and its value rating to selected consumer members.

3. The method of claim 1, the step of receiving the value rating further comprising receiving an initial value rating from at least one consumer member.

4. The method of claim 1, the step of receiving the value rating further comprising receiving an initial value rating and a plurality of additional value ratings.

5. The method of claim 1, wherein the value rating is received from at least one consumer member, at least one business member, or a service provider that hosts and displays discount coupon offers.

6. The method of claim 1, wherein the step of providing access further comprises limiting access to consumer members from whom configuration data is received, including at least one keyword or phrase describing a topic of interest matching a discount coupon offer.

7. The method of claim 6, wherein configuration data further includes a minimum value rating, and the value rating of the discount coupon offer meets or exceed the minimum value rating.

8. The method of claim 4, the posting step further comprising posting both the initial value rating and the additional value rating.

9. The method of claim 4, the posting step further comprising replacing the initial value rating with the additional value rating.

10. The method of claim 4, the posting step further comprising:
calculating an average of the additional value ratings and posting the average as the value rating.

11. The method of claim 4, the posting step further comprising:
calculating an average of the additional value ratings and the initial value rating and posting the average as the value rating.

12. The method of claim 4, the posting step further comprising:
calculating a defined formulation using the additional value ratings and the initial value rating and posting the defined formulation as the value rating.

13. A non-transitory computer-readable storage medium encoded with computer-executable instructions to perform the method of claim 1.

14. An apparatus for displaying electronic distribution of discount coupon offers to consumers, comprising:
a data store;
a server hosting a network-based service and coupled to the data store, the network-based service accessible to a plurality of consumer members and a plurality of business members;
a plurality of communication ports on the server configured for providing input to the network-based service, including a first set of ports assigned to consumer members and a second set of ports assigned to business members; and
a display;
wherein the network-based service is configured to receive at least one discount coupon offer at the second set of ports from at least one business member; to assign at least one value rating to the discount coupon offer; and to display the value rating together with the discount coupon offer.

15. The apparatus of claim 14, wherein the value rating includes an initial value rating.

16. The apparatus of claim 14, wherein the value rating includes an initial value rating and a plurality of additional value ratings.

17. The apparatus of claim 14, wherein the value rating comprises an average of a plurality of value ratings.

18. The apparatus of claim 14, wherein the value rating comprises a defined formulation using a plurality of value ratings.

19. The apparatus of claim 14, wherein the value rating is received from at least one consumer member, at least one business member, or a service provider that hosts and displays discount coupon offers.

20. The apparatus of claim 14, wherein access to the network-based service is limited to consumer members from whom configuration data is received, including at least one keyword or phrase describing a topic of interest matching a discount coupon offer.
